(19) United States
(12) Patent Application Publication
(10) Pub. No.: US 2021/0117726 A1
(43) Pub. Date: Apr. 22, 2021

(54) METHOD FOR TRAINING IMAGE CLASSIFYING MODEL, SERVER AND STORAGE MEDIUM

(71) Applicant: BEIJING DAJIA INTERNET INFORMATION TECHNOLOGY CO., LTD., Beijing (CN)

(72) Inventors: Zhiwei ZHANG, Beijing (CN); Yan LI, Beijing (CN); Lijun WU, Beijing (CN)

(21) Appl. No.: 17/137,282

(22) Filed: Dec. 29, 2020

Related U.S. Application Data
(63) Continuation of application No. PCT/CN2018/123959, filed on Dec. 26, 2018.

(30) Foreign Application Priority Data
Jun. 29, 2018 (CN) 201810712097.7

(51) Int. Cl. G06K 9/62

(52) U.S. Cl. CPC G06K 9/6256; G06K 9/6267; G06K 9/6215

(57) ABSTRACT

A method for training an image classifying model can include: selecting a plurality of sample images from a sample image set; determining a plurality of sample image pairs according to a tag ratio diagram; building a target loss function based on the plurality of sample image pairs, and training a first image classifying model based on the target loss function to determine the image classifying model.

### CROSS-REFERENCE TO RELATED APPLICATIONS

This application is a continuation application of International Application No. PCT/CN2018/123959, filed on Dec. 26, 2018 and entitled “METHOD, DEVICE, AND SERVER FOR IMAGE TAG IDENTIFICATION”, which claims priority to Chinese Patent Application No. 201810712097.7, filed on Jun. 29, 2018 and entitled “IMAGE LABEL RECOGNITION METHOD, DEVICE AND SERVER”, the disclosure of each of which is incorporated herein by reference in its entirety.

### TECHNICAL FIELD

The present disclosure relates to the field of image processing technologies, and in particular to a method for training an image classifying model, a server and a storage medium.

### BACKGROUND

Deep learning is widely used in such related fields as video images, speech recognition and natural language processing. The convolutional neural network, as an important branch of the deep learning, greatly improves the precision of its prediction results obtained in computer vision tasks such as target detection, classification and the like because of its super fitting ability and end-to-end global optimization ability. Intermediate results of multimedia data such as video images and the like during layer-to-layer propagation in the convolutional neural network are also stripped out from a model as the features for describing input data. These features are also widely used in the fields such as similar face detection, video image retrieval and the like.

### SUMMARY

To resolve a problem existing in the related art, the present disclosure provides a method and apparatus for training an image classifying model and a server.

In one aspect, a method for training an image classifying model includes: selecting a plurality of sample images from a sample image set including pre-tagged sample images; determining a plurality of sample image pairs according to a tag ratio diagram, wherein each sample image pair includes one sample image, and a most similar sample image and a most difficult sample image of the sample image, the tag ratio diagram is built by the sample image set and a first image classifying model trained based on the sample image set, and the tag ratio diagram includes various tags and a prediction ratio of that each tag is predicted to be another tag; building a target loss function based on the plurality of sample image pairs; training the first image classifying model based on the target loss function to obtain a second image classifying model; and performing, based on the second image classifying model, tag identification on an image to be identified.

In another aspect, a server is provided and includes a memory, a processor and a computer program which is stored on the memory and is capable of being executed on the processor. The computer program, when executed by the processor, implements the following steps:

selecting a plurality of sample images from a sample image set including pre-tagged sample images;

determining a plurality of sample image pairs according to a tag ratio diagram, wherein each sample image pair includes one sample image, and a most similar sample image and a most difficult sample image of the sample image, the tag ratio diagram is built by the sample image set and a first image classifying model trained based on the sample image set, and the tag ratio diagram includes various tags and a prediction ratio of that each tag is predicted to be another tag;

building a target loss function based on the plurality of sample image pairs;

training the first image classifying model based on the target loss function to obtain a second image classifying model; and

performing, based on the second image classifying model, tag identification on an image to be identified.

In yet another aspect, a computer-readable storage medium is provided. A computer program is stored on the computer-readable storage medium, and when executed by a processor, the computer program implements the following steps:

selecting a plurality of sample images from a sample image set including pre-tagged sample images;

determining a plurality of sample image pairs according to a tag ratio diagram, wherein each sample image pair includes one sample image, and a most similar sample image and a most difficult sample image of the sample image, the tag ratio diagram is built by the sample image set and a first image classifying model trained based on the sample image set, and the tag ratio diagram includes various tags and a prediction ratio of that each tag is predicted to be another tag;

building a target loss function based on the plurality of sample image pairs;

training the first image classifying model based on the target loss function to obtain a second image classifying model; and

performing, based on the second image classifying model, tag identification on an image to be identified.

### BRIEF DESCRIPTION OF THE DRAWINGS

The accompanying drawings herein are incorporated in and form part of the description, illustrate the embodiments of the present disclosure and, together with the description, serve to explain the principles of the present disclosure.

FIG. 1 is a flow diagram illustrating steps of a method for training an image classifying model according to an embodiment;

FIG. 2 is a flow diagram illustrating steps of another method for training an image classifying model according to an embodiment;

FIG. 3 is a block diagram illustrating an apparatus for training an image classifying model according to an embodiment;

FIG. 4 is a block diagram illustrating a terminal for training a classifying model according to an embodiment; and

FIG. 5 is a block diagram illustrating a server according to an embodiment.

### DETAILED DESCRIPTION

Description will be made here in detail to an embodiment, examples of which are illustrated in the accompanying drawings. The following description refers to the accompanying drawings in which the same numbers in different drawings represent similar elements unless otherwise represented. The implementations set forth in the following description do not represent all implementations consistent with the present disclosure. Rather, they are only examples of devices and methods which are set forth in the accompanying claims and consistent with some aspects of the present disclosure.

In the related arts, although the intermediate results of the convolutional neural network are able to be stripped out as the features to be directly used to the fields such similar face detection and the like, the features directly obtained from the convolutional neural network have the following disadvantages.

I. The granularity of the extracted features is relatively coarse, i.e. the features may generate distinguishing effects, but the distinguishing effects are poor. II. This feature extraction method may select the most-difficult sample from samples in the same batch as a loss to be used in calculation, and the convergence rate of the model is low when the model is classified by images trained by the features extracted using this feature extraction method. The above two disadvantages finally cause the problems of low tag identification accuracy and high training difficulty of the image classification model.

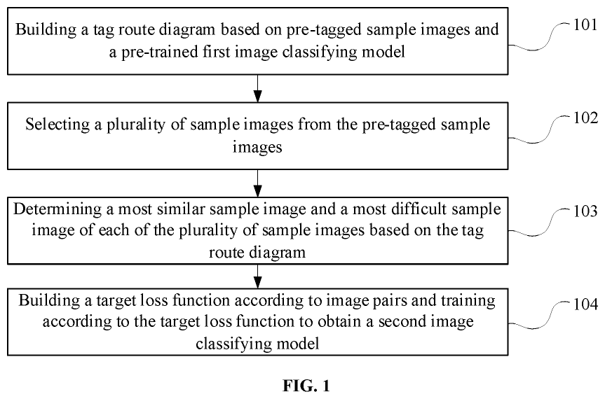

FIG. 1 is a flow diagram illustrating steps of a method for training an image classifying model according to an embodiment, and the method for training the image classifying model as shown in FIG. 1 is used for a terminal and includes the following steps.

In 101, building a tag route diagram based on pre-tagged sample images and a pre-trained first image classifying model. In some embodiments, the terminal can build the tag route diagram based on the pre-tagged sample images and the pre-trained first image classifying model.

Training of a first image classifying model may be finished with reference to an existing manner, and a concrete training manner of the first image classifying model is not specifically limited in the present embodiment. The tag route diagram contains a plurality of tags and route ratios of each tag to another tag.

When the tag route diagram is built, tag prediction can be performed on each of the pre-tagged sample images based on the first image classifying model to obtain a target tag corresponding to each sample image; and then the route ratios of tags to tags is determined, and the tag route diagram is drawn finally based on the route ratios of tags to tags.

In some embodiments, the tag route diagram is a tag ratio diagram built by identifying a sample image set based on the first image classifying model. The tag ratio diagram includes various tags and a prediction ratio of that each tag is predicted to be another tag.

In 102, selecting a plurality of sample images from the pre-tagged sample images. In some embodiments, the terminal can select a plurality of sample images from the pre-tagged sample images.

In some embodiments, a plurality of sample images is selected from the sample image set, and the number of the plurality of sample images can be set by those skilled in the art according to actual needs, which is not specifically limited in the present embodiment.

In 103, determining a most similar sample image and a most difficult sample image of each of the plurality of sample images based on the tag route diagram. In some embodiments, the terminal can determine the most similar sample image and the most difficult sample image of each of the sample images based on the tag route diagram.

The sample image, the most similar sample image of the sample image and the most difficult sample image of the sample image constitute a sample image pair. In other words, each sample image pair includes one sample image, and the most similar sample image and the most difficult sample image of the sample image.

In 104, building a target loss function according to image pairs and training according to the target loss function to obtain a second image classifying model. In some embodiments, the terminal can build the target loss function according to the image pairs and train according to the target loss function to obtain the second image classifying model.

The most similar sample image and the most difficult sample image in each image pair, an image pair loss average calculation function can be built based on the tag route ratio of the sample image, and a sum of the image pair loss average calculation function and a preset classification loss function weight is the built target loss function.

Weights of the image pair loss average calculation function and the preset classification loss function can be set by those skilled in the art according to actual needs.

Training of the second image classifying model is substantially to continuously update parameters of the model till the second image classifying model converges to a preset standard, and then image tag prediction can be performed. It can be determined that the first image classifying model converges to the preset standard when an average loss value is smaller than a preset loss value during training of the second image classifying model. The preset loss value can be set by those skilled in the art according to actual needs. The smaller the preset loss value is, the better the convergence of the trained second image classifying model is; and the larger the preset loss value is, the easier the training of the second image classifying model is.

In some embodiments, the second image classifying model is a target image classifying model. A plurality of sample image pairs can be determined based on the tag ratio diagram. The target loss function can be built based on the plurality of sample image pairs. After that, the first image classifying model can be trained based on the target loss function to determine the target image classifying model.

In some embodiments, the image pair loss average calculation function is a loss function. The loss function is built based on the plurality of sample image pairs, and is determined based on a first desired distance between each sample image and the most similar sample image of the corresponding sample image, a second desired distance between each sample image and the most difficult sample image of the corresponding sample image and a minimal distance between the first desired distance and the second desired distance. Weighted summation is performed on the loss function and a classification loss function to obtain a target loss function. The classification loss function indicates classification loss of the first image classifying model.

In some embodiments, tag identification is performed, based on the second image classifying model, on an image to be identified.

The image to be identified can be a single-frame image in a video or one multimedia image. The image to be identified is input into the second image classifying model, and a tag identification result can be output after prediction by the model.

The method for training the image classifying model, shown by the example embodiment, is high in model convergence rate and refined in tag classification, and the tag identification accuracy of the target image classifying model is high.

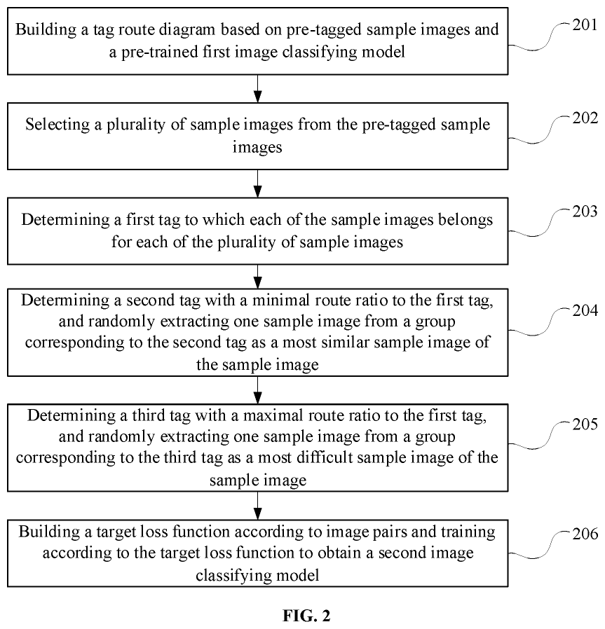

FIG. 2 is a flow diagram of a method for training an image classifying model according to an embodiment, and the method for training the image classifying model as shown in FIG. 2 is used for a terminal and includes the following steps.

In 201, building a tag route diagram based on pre-tagged sample images and a pre-trained first image classifying model. In some embodiments, the terminal can build the tag route diagram based on the pre-tagged sample images and the pre-trained first image classifying model.

A way for building the tag route diagram is described as below.

First, tag prediction is performed on the pre-tagged sample images based on the pre-trained first image classifying model to obtain a target tag corresponding to each sample image.

Each sample image corresponds to a preset number of target tags. The preset number can be set by those skilled in the art according to actual needs, for example, the preset number is 2, 3, 4 or the like.

In some embodiments, determining the target tag corresponding to each sample image includes: performing tag prediction on each pre-tagged sample image based on the pre-trained first image classifying model to obtain a prediction vector of each sample image, wherein the prediction vector contains a plurality of points, and each point corresponds to one tag and one probability value; sorting the probability values of all the points in each prediction vector from largest to smallest for each prediction vector; and determining tags corresponding to a preset number of the probability values ranking ahead as the target tags of the sample image corresponding to the prediction vector.

Second, the pre-tagged sample images are grouped according to tags.

The tags are preset tags, and each sample image is pre-tagged with a tag. Each tag corresponds to one group, such that the group corresponding to one tag includes one or more pre-tagged sample images.

Third, the number of the tags in the target tags is determined for each of the tags. For each group, a quotient of the number of the tags and the number of the sample images in the group is determined as a route ratio of the tags to the tag corresponding to the group.

Due to the plurality of pre-tagged sample images, each of the pre-tagged sample images corresponds to the preset number of target tags, and the same tags may exist among the target tags corresponding to each of the sample images, such that a plurality of tags may exist among the target tags for each of the tags, and the first number of the tags in the target tags can be counted.

Each group includes at least one sample image, such that the second number of the sample images included in the group can be counted, and a quotient of the first number and the second number is calculated finally and is determined as a route ratio of the tags to the tag corresponding to the group.

rⱼ=1/nΣᵢ₌₁ⁿp_{i,j},

wherein rⱼ refers to the route ratio, n refers to the number of the sample images, i refers to a sample image identifier, and j refers to a tag identifier.

This step is repeatedly executed, and the route ratio of each tag to the tags corresponding to each group can be determined, that is, route ratios of tags to tags can be determined.

Finally, the tag route diagram is drawn according to route ratios of tags to tags.

In some embodiments, the tag route diagram is a tag ratio diagram built by identifying the sample image set based on the first image classifying model. The tag ratio diagram includes various tags and a prediction ratio of that each tag is predicted to be another tag.

In some embodiments, generating the tag ratio diagram includes: determining a plurality of target tags corresponding to each sample image according to the first image classifying model; determining a prediction ratio of that each tag is predicted to be another tag based on the plurality of target tags and a pre-tagged first tag of each sample image; and generating the tag ratio diagram based on the prediction ratio.

In some embodiments, determining the plurality of target tags corresponding to each sample image according to the first image classifying model includes: determining a prediction vector of each sample image based on the first image classifying model, wherein the prediction vector contains a plurality of tags and a probability value corresponding to each tag; and determining tags of which the probability values rank ahead as target tags of the sample image corresponding to the prediction vector.

In some embodiments, determining the prediction ratio of that each tag is predicted to be another tag based on the plurality of target tags and the pre-tagged first tag of each sample image includes: grouping the plurality of sample images according to the pre-tagged first tag, one tag corresponding to one group; for each group, determining the number of each tag in the plurality of target tags corresponding to each sample image in the group; and determining a quotient of the number of each tag and the number of the sample images in the group as a prediction ratio of that the tag corresponding to the group is predicted to be each tag.

In 202, selecting a plurality of sample images from the pre-tagged sample images. In some embodiments, the terminal can select a plurality of sample images from the pre-tagged sample images.

In some embodiments, a plurality of sample images is selected from a sample image set. The number of the plurality of sample images can be set by those skilled in the art according to actual demands, which is not specifically limited in the embodiments of the present disclosure.

In 203, determining a first tag to which each of the sample images belongs for each of the plurality of sample images. In some embodiments, the terminal can determine the first tag to which each of the sample images belongs for each of the plurality of sample images.

Each sample image belongs to one group, each group corresponds to one tag, and the tag corresponding to the group to which each sample image belongs is a first tag to which the sample image belongs.

In 204, determining a second tag with a minimal route ratio to the first tag, and randomly extracting one sample image from a group corresponding to the second tag as a most similar sample image of the sample image. In some embodiments, the terminal can determine the second tag with the minimal route ratio to the first tag, and randomly extract one sample image from the group corresponding to the second tag as the most similar sample image of the sample image.

For example, if the group corresponding to the second tag contains 10 sample images, one sample image is randomly extracted from the 10 sample images as the most similar sample image of the sample image.

In 205, determining a third tag with a maximal route ratio to the first tag, and randomly extracting one sample image from a group corresponding to the third tag as a most difficult sample image of the sample image. In some embodiments, the terminal can determine the third tag with the maximal route ratio to the first tag, and randomly extract one sample image from the group corresponding to the third tag as the most difficult sample image of the sample image.

The sample image, the most similar sample image of the sample image and the most difficult sample image of the sample image constitute an image pair. In 203 to 205, the most difficult sample image and the most similar sample image of one sample image are determined, and the three of the sample image, the most difficult sample image thereof and the most similar sample image thereof constitute one image pair. In the specific implementation process, the above flow can be repeatedly executed to determine the image pair corresponding to each sample image.

In some embodiments, the route ratio diagram is a tag ratio diagram, and the route ratio is a prediction ratio. The second tag with a minimal prediction ratio to and the third tag with a maximal prediction ratio to the first tag of each sample image are determined according to the tag ratio diagram; one sample image is randomly extracted from the group corresponding to the second tag as the most difficult sample image of each sample image; one sample image is randomly extracted from the group corresponding to the third tag as the most similar sample image of each sample image; each sample image, the most similar image of the sample image and the most difficult sample image of the sample image are determined as a sample image pair of each sample image.

In 206, building a target loss function according to image pairs and training according to the target loss function to obtain a second image classifying model. In some embodiments, the terminal can build the target loss function according to the image pairs and train according to the target loss function to obtain the second image classifying model.

Based on the tag route ratio of the image pair, the most similar sample image and the most difficult sample image in each image pair, an image pair loss average calculation function can be built as follows:

tripletloss=dis(x^{a},x^{p})−dis(x^{a},xⁿ)+a,

wherein dis( ) refers to a distance measurement function, i.e. a tag-to-tag route ratio measurement function; xₐ, xₚ and xₙ refer to the sample image, the most similar sample image and the most difficult sample image respectively; and a refers to a minimal distance.

The sum of the image pair loss average calculation function and the preset classification loss function weight is the constructed target loss function, and the target loss function can be expressed by the following formula:

loss=λₜᵣᵢₚₗₑₜlossₜᵣᵢₚₗₑₜ+λ_{clf}loss_{clf},

wherein loss represents the target loss function, lossₜᵣᵢₚₗₑₜ represents the image pair loss average calculation function, loss_{clf} represents the preset classification loss function, λₜᵣᵢₚₗₑₜ represents the weight of the lossₜᵣᵢₚₗₑₜ, and λ_{clf} represents a weight of loss_{clf}.

In some embodiments, the image pair loss average calculation function is a triplet loss function. A triplet loss function is built based on the plurality of sample image pairs. The triplet loss function includes a first desired distance between each sample image and the most similar sample image of the corresponding sample image, a second desired distance between each sample image and the most difficult sample image of the corresponding sample image and a minimal distance between the first desired distance and the second desired distance. Weighted summation is performed on the triplet loss function and a classification loss function to obtain a target loss function. The classification loss function is intended to indicate classification loss of the first image classifying model.

In some embodiments, tag identification is performed on an image to be identified based on the second image classifying model.

The image to be identified can be a single-frame image in a video or one multimedia image. The image to be identified is input into the second image classifying model, and a tag identification result can be output after prediction by the model.

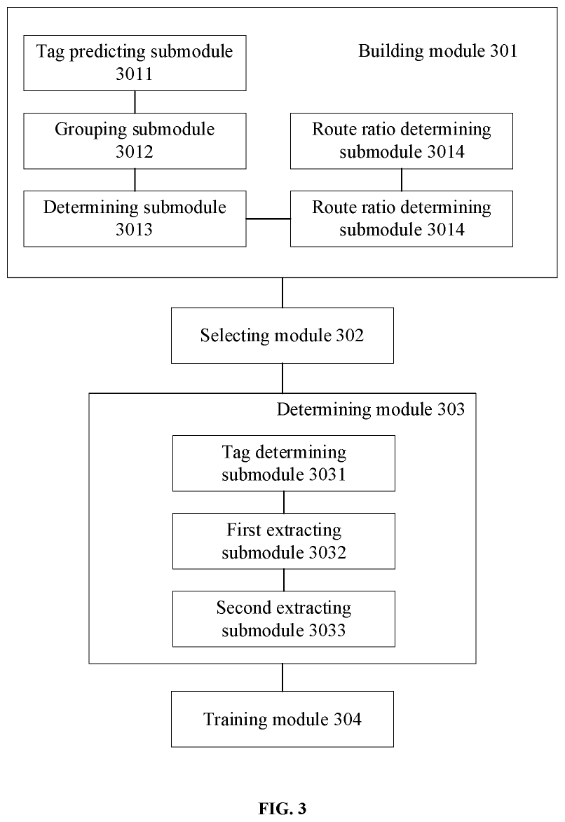

FIG. 3 is a block diagram illustrating an apparatus for training an image classifying model according to an embodiment. Referring to FIG. 3, the apparatus includes a building module 301, a selecting module 302, a determining module 303 and a training module 304.

The building module 301 is configured to construct a tag route diagram based on pre-tagged sample images and pre-trained first image classifying model; the selecting module 302 is configured to select a plurality of sample images from the pre-tagged sample images; the determining module 303 is configured to determine a most similar sample image and a most difficult sample image of each sample image by means of the tag route diagram, wherein each sample image, the most similar sample image of the sample image and the most difficult sample image of the sample image constitute an image pair; the training module 304 is configured to build a target loss function based on the image pair and to perform training based on the target loss function to obtain a second image classifying model; and an identifying module 305 is configured to perform tag identification on an image to be identified via the second image classifying model.

In some embodiments, the building module 301 may include a tag predicting submodule 3011 configured to perform tag prediction on the pre-tagged sample images by the pre-trained first image classifying model to obtain target tags corresponding to each of the sample images, wherein each of the sample images corresponds to a preset number of the target tags; a grouping submodule 3012 configured to group the pre-tagged sample images according to tags, wherein each of the tags corresponds to one group; a determining submodule 3013 configured to determine the number of each of the tags among the target tags for each of the tags; a route ratio determining submodule 3014 configured to determine a quotient of the number of the tags and the number of the sample images for each of the groups as a route ratio of the tags to the tag corresponding to the group; and a drawing submodule 3015 configured to draw the tag route diagram according to route ratios of tags to tags.

In some embodiments, the tag prediction submodule 3011 may include: a vector predicting unit configured to perform tag prediction on the pre-tagged sample images by the pre-trained first image classifying model to obtain a prediction vector corresponding to each of the sample images, wherein the prediction vector contains a plurality of points, and each of the points corresponds to one tag and one probability value; a sorting unit configured to sort the probability values of all the points in each of the prediction vectors from largest to smallest for each of the prediction vectors; and a target tag determining unit configured to determine tags corresponding to a preset number of the probability values ranking ahead as the target tags of each of the sample images corresponding to each of the prediction vectors.

In some embodiments, the determining module 303 may include: a tag determining submodule 3031 configured to, for each of the sample images, determine a first tag to which the sample image belongs among the sample images in the same batch; a first extracting submodule 3032 configured to determine a second tag with the minimal route ratio to the first tag and randomly extract one sample image from a group corresponding to the second tag as the most similar sample image of the sample image; and a second extracting submodule 3033 configured to determine a third tag with the maximal route ratio to the first tag and randomly extract one sample image from a group corresponding to the third tag as the most difficult sample image of each of the sample images.

In some embodiments, the target loss function is a sum of an image pair loss average calculation function and a preset classification loss function weight.

In some embodiments, the selecting module 302 is configured to select a plurality of sample images from a sample image set including pre-tagged sample images;

the determining module 303 is configured to: determine a plurality of sample image pairs according to a tag ratio diagram, wherein each sample image pair includes one sample image, and a most similar sample image and a most difficult sample image of the sample image, the tag ratio diagram is built by identifying the sample image set based on a first image classifying model, and the tag ratio diagram includes various tags and a prediction ratio of that each tag is predicted to be another tag;

the training module 304 is configured to build a target loss function based on the plurality of sample image pairs; and

the training module 304 is further configured to train the first image classifying model based on the target loss function to determine a target image classifying model.

In some embodiments, the building module 301 is configured to: determine a plurality of target tags corresponding to each sample image according to the first image classifying model; determine a prediction ratio of that each tag is predicted to be another tag based on the plurality of target tags and a pre-tagged first tag of each of the sample images; and generate the tag ratio diagram based on the prediction ratio.

In some embodiments, the building module 301 is configured to: determine a prediction vector of each sample image based on the first image classifying model, wherein the prediction vector contains a plurality of tags and a probability value corresponding to each tag; and determine tags of which the probability values rank ahead as target tags of the sample image corresponding to the prediction vector.

In some embodiments, the building module 301 is configured to: group the plurality of sample images according to the pre-tagged first tag, one tag corresponding to one group; for each group, determine the number of each tag in the plurality of target tags corresponding to each sample image in the group; and determine a quotient of the number of each tag and the number of the sample images in the group as a prediction ratio of that the tag corresponding to the group is predicted to be each tag.

In some embodiments, the determining module 303 is configured to: determine a second tag with a minimal prediction ratio to and a third tag with a maximal prediction ratio to the first tag of each sample image according to the tag ratio diagram; randomly extract one sample image from a group corresponding to the second tag as a most difficult sample image of each sample image; randomly extract one sample image from a group corresponding to the third tag as a most similar sample image of each sample image; and determine each sample image, the most similar sample image of each sample image and the most difficult sample image of each sample image as a sample image pair of each sample image.

In some embodiments, the training module 304 is configured to: build a loss function based on the plurality of sample image pairs, the loss function being determined based on a first desired distance between each sample image and the most similar sample image of the corresponding sample image, a second desired distance between each sample image and the most difficult sample image of the corresponding sample image and a minimal distance between the first desired distance and the second desired distance; and perform weighted summation on the loss function and a classification loss function to obtain a target loss function, the classification loss function indicating classification loss of the first image classifying model.

For the apparatus in the foregoing embodiment, a specific manner of each of the modules in performing an operation is already described in the method-related embodiment in detail, and is no longer described herein in detail.

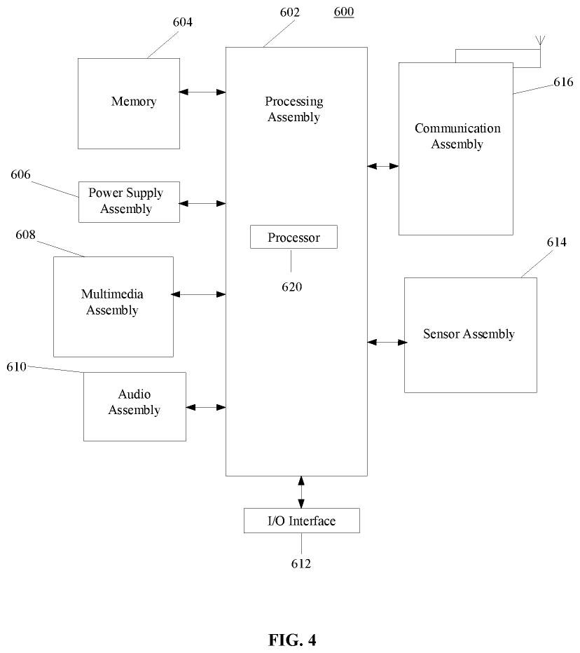

FIG. 4 is a block diagram illustrating a terminal 600 for training an image classifying model according to an embodiment. For example, the terminal 600 can be a mobile telephone, a computer, a digital broadcast terminal, a message receiving and transmitting device, a game console, a tablet device, medical equipment, body building equipment, a personal digital assistant and the like.

With reference to FIG. 4, the terminal 600 may include one or more of the following assemblies: a processing assembly 602, a memory 604, a power supply assembly 606, a multimedia assembly 608, an audio assembly 610, an input/output (I/O) interface 612, a sensor assembly 614 and a communication assembly 616.

The processing assembly 602 generally controls the overall operations of the device 600, such as the operations associated with display, phone calling, data communication, camera operation and recording operation. The processing assembly 602 may include one or more processors 620 to execute instructions to complete the whole or a part of the steps of the method. In addition, the processing assembly 602 may include one or more modules to facilitate interaction between the processing assembly 602 and other assemblies. For example, the processing assembly 602 may include a multimedia module to facilitate interaction between the multimedia assembly 608 and the processing assembly 602.

The memory 604 is configured to store various types of data to support the operations of the device 600. The examples of the data include an instruction, contact data, telephone directory data, a message, an image, a video and the like of any application program or method used for being operated on the device 600. The memory 604 can be any types of volatile or non-volatile storage devices or a combination thereof, such as a static random access memory (SRAM), an electrically-erasable programmable read-only memory (EEPROM), an erasable programmable read-only memory (EPROM), a programmable read-only memory (PROM), a read-only memory (ROM), a magnetic memory, a flash memory, a magnetic disk or an compact disk.

The power supply assembly 606 supplies power to various assemblies of the device 600. The power supply assembly 606 may include a power supply management system, one or more power supplies and other assemblies for generating, managing and allocating power for the device 600.

The multimedia assembly 608 includes a screen between the device 600 and a user and capable of providing an output interface. In some embodiments, the screen may include a liquid crystal display (LCD) and a touch panel (TP). The screen can be implemented as a touch screen to receive an input signal from the user if including the touch panel. The touch panel includes one or more touch sensors to sense a touching gesture, a sliding gesture and a gesture on the touch panel. A touch sensor can sense a border of a touch or sliding movement and further detect a duration and pressure related to a touch or sliding operation. In some embodiments, the multimedia assembly 608 includes a front camera and/or a rear camera. When the device 600 is in an operating mode, for example, a photographing mode or a video mode, the front camera and/or the rear camera can receive external multimedia data. Each of the front camera and the rear camera can be a fixed optical lens system or has a focal length and the optical zoom capability.

The audio assembly 610 is configured to output and/or input an audio signal. For example, the audio assembly 610 includes a microphone (MIC) configured to receive an external audio signal when the device 600 is in an operating mode, such as a calling mode, a recording mode and a voice recognition mode. The received audio signal can be further stored in the memory 604 or transmitted via the communication assembly 616. In some embodiments, the audio assembly 610 further includes a loudspeaker configured to output the audio signal.

The I/O interface 612 is an interface provided between the processing assembly 602 and a peripheral interface module, and the peripheral interface module can be a keyboard, a click wheel, a button and the like. The buttons may include but not limited to a homepage button, a volume button, an activation button and a lock button.

The sensor assembly 614 includes one or more sensors configured to supply various aspects of state evaluations to the device 600. For example, the sensor assembly 614 can detect an on/off state of the device 600 and relative positioning of the assemblies, for example, the assemblies are a display and a small keyboard of the device 600; and the sensor assembly 614 can further detect position change of the device 600 or one assembly of the device 600, contact or non-contact of the user and the device 600, the azimuth of the device 600 or acceleration/deceleration and temperature change of the device 600. The sensor assembly 614 may include a proximity sensor configured to detect existence of an object nearby without any physical contact. The sensor assembly 614 can further include a light sensor, such as a CMOS or a CCD image sensor, for use in an imaging application. In some embodiments, the sensor assembly 614 can further include an acceleration sensor, a gyroscope sensor, a magnetic sensor, a pressure sensor or a temperature sensor.

The communication assembly 616 is configured to facilitate wired or wireless communication between the device 600 and other equipment. The device 600 can access a communication standard based wireless network, such as WiFi, 2G, 3G or a combination thereof. In one embodiment, a communication assembly 616 receives a broadcasting signal or broadcast-related information from an external broadcasting management system via a broadcast channel. In one embodiment, the communication assembly 616 further includes a near-field communication (NFC) module to promote short-range communication. For example, the NFC module can be implemented based on a radio frequency identification (RFID) technology, an infrared data association (IrDA) technology, an ultrawide band (UWB) technology, a Bluetooth (BT) technology and other technologies.

In an embodiment, the device 600 can be implemented by one or more application-specific integrated circuits (ASIC), a digital signal processor (DSP), a digital signal processing device (DSPD), a programmable logic device (PLD), a field-programmable gate array (FPGA), a controller, a microcontroller, a microprocessor or other electronic elements and is configured to execute the method.

In an embodiment, further provided is a non-transitory computer readable storage medium, including an instruction, for example, a memory 604 including the instruction; and the instruction can be executed by the processor 620 of the device 600 to finish the method. For example, the non-transitory computer readable storage medium can be a ROM, a random-access memory (RAM), a CD-ROM, a magnetic tape, a floppy disk, an optical data storage device and the like.

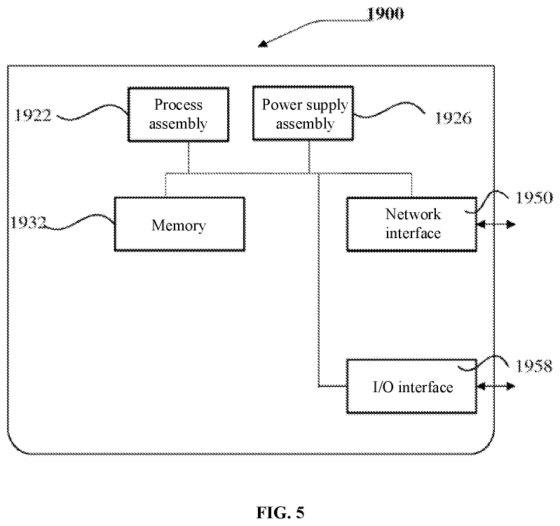

FIG. 5 is a block diagram illustrating an apparatus 1900 for image tag identification according to an embodiment. For example, the apparatus 1900 can be supplied as a server. Referring to FIG. 5, the apparatus 1900 includes a processing assembly 1922 and further includes one or more processors and a memory resource configured to store the instruction (such as an application program) capable of being executed by the processing assembly 1922 and represented by the memory 1932. The application program stored in the memory 1932 may include each of one or more modules corresponding to a group of instructions. Additionally, the processing assembly 1922 is configured to execute the instruction to execute the method, the executing the instruction to execute the method concretely includes:

building a tag route diagram based on pre-tagged sample images and pre-trained first image classifying model; selecting a plurality of sample images from the pre-tagged sample images; determining a most similar sample image and a most difficult sample image of each of the sample images among the sample images in the same batch by means of the tag route diagram, wherein each sample image, the most similar sample image of the sample image and the most difficult sample image of the sample image constitute an image pair; building a target loss function according to the image pairs and training according to the target loss function to obtain a second image classifying model; and performing tag identification on an image to be identified based on the second image classifying model.

In some embodiments, building the tag route diagram based on the pre-tagged sample images and the pre-trained first image classifying model includes:

performing tag prediction on the pre-tagged sample images by the pre-trained first image classifying model to obtain a target tag corresponding to each sample image, wherein each of the sample images corresponds to a preset number of the target tags; grouping the pre-tagged sample images according to tags, wherein each of the tags corresponds to one group; determining the number of each of the tags among the target tags for each of the tags; determining a quotient of the number of the tags and the number of the sample images in a group as a route ratio of the tags to the tag corresponding to the group; and drawing the tag route diagram according to route ratios of tags to tags.

In some embodiments, performing tag prediction on each of the pre-tagged sample images by means of the pre-trained first image classifying model to obtain the target tags corresponding to each of the sample images includes: performing tag prediction on the pre-tagged sample images by the pre-trained first image classifying model to obtain a prediction vector corresponding to each of the sample images, wherein the prediction vector contains a plurality of points, and each of the points corresponds to one tag and one probability value; sorting the probability values of all the points in each of the prediction vectors from largest to smallest for each of the prediction vectors; and determining tags corresponding to a preset number of the probability values ranking ahead as the target tags of each of the sample images corresponding to each of the prediction vectors.

In some embodiments, determining the most similar sample image and the most difficult sample image of each of the sample images in the sample images in the same batch by means of the tag route diagram includes: for each of the sample images, determining a first tag to which the sample image belongs in the sample images in the same batch; determining a second tag with a minimal route ratio to the first tag, and randomly extracting one sample image from a group corresponding to the second tag as the most similar sample image of the sample image; determining a third tag with a maximal route ratio to the first tag, and randomly extracting one sample image from a group corresponding to the third tag as the most difficult sample image of each of the sample images.

In some embodiments, the target loss function is a sum of an image pair loss average calculation function and a preset classification loss function weight.

The apparatus 1900 may further include a power supply assembly 1926 configured to execute power supply management of the apparatus 1900, a wired or wireless network interface 1950 configured to connect the apparatus 1900 to a network and an input/output (I/O) interface 1958. The apparatus 1900 can operate an operating system stored on the memory 1932, such as Windows Server™, Mac OS X™, Unix™, Linux™, FreeBSD™ or the like.

In some embodiments, the server includes a memory, a processor and a program for training an image classifying model. The program is stored on the memory and operable on the processor, and when executed by the processor, the program implements the following steps:

selecting a plurality of sample images from a sample image set including pre-tagged sample images;

determining a plurality of sample image pairs according to a tag ratio diagram, wherein each sample image pair includes one sample image, and a most similar sample image and a most difficult sample image of the sample image, the tag ratio diagram is built by identifying the sample image set by a first image classifying model, and the tag ratio diagram includes various tags and a prediction ratio of that each tag is predicted to be another tag;

building a target loss function based on the plurality of sample image pairs; and

training the first image classifying model based on the target loss function to determine a target image classifying model.

In some embodiments, the program for training the image classifying model, when executed by the processor, implements the following steps:

determining a plurality of target tags corresponding to each sample image based on the first image classifying model;

determining a prediction ratio of that each tag is predicted to be another tag based on the plurality of target tags and a pre-tagged first tag of each sample image; and

generating the tag ratio diagram based on the prediction ratio.

In some embodiments, the program for training the image classifying model, when executed by the processor, implements the following steps:

determining a prediction vector of each sample image based on the first image classifying model, the prediction vector containing a plurality of tags and a probability value corresponding to each tag; and

determining tags of which the probability values rank ahead as target tags of the sample image corresponding to the prediction vector.

In some embodiments, the program for training the image classifying model, when executed by the processor, implements the following steps:

grouping the plurality of sample images according to the pre-tagged first tag, one tag corresponding to one group;

for each group, determining the number of each tag in the plurality of target tags corresponding to each sample image in the group; and

determining a quotient of the number of each tag and the number of the sample images in the group as a prediction ratio of that the tag corresponding to the group is predicted to be each tag.

In some embodiments, the program for training the image classifying model, when executed by the processor, implements the following steps:

determining a second tag with a minimal prediction ratio to and a third tag with a maximal prediction ratio to the first tag of each sample image according to the tag ratio diagram;

randomly extracting one sample image from a group corresponding to the second tag as a most difficult sample image of each sample image;

randomly extracting one sample image from a group corresponding to the third tag as a most similar sample image of each sample image; and

determining each sample image, the most similar sample image of the sample image and the most difficult sample image of the sample image as a sample image pair of each sample image.

In some embodiments, the program for training the image classifying model, when executed by the processor, implements the following steps:

building a loss function based on the plurality of sample image pairs, wherein the loss function is determined based on a first desired distance between each sample image and the most similar sample image of the corresponding sample image, a second desired distance between each sample image and the most difficult sample image of the corresponding sample image and a minimal distance between the first desired distance and the second desired distance; and

performing weighted summation on the loss function and a classification loss function to obtain a target loss function, the classification loss function indicating classification loss of the first image classifying model.

The present disclosure provides a computer readable storage medium at the same time; a program for training an image classifying model is stored on the computer readable storage medium; and the program for training an image classifying model, when being executed by the processor, implements the steps in any one of the above methods for training an image classifying model.

The present disclosure provides a computer readable storage medium at the same time; a program for training an image classifying model is stored on the computer readable storage medium; and when executed by the processor, the program implements the following steps:

selecting a plurality of sample images from a sample image set including pre-tagged sample images;

determining a plurality of sample image pairs according to a tag ratio diagram, wherein each sample image pair includes one sample image, and a most similar sample image and a most difficult sample image of the sample image, the tag ratio diagram is built by identifying the sample image set by a first image classifying model, and the tag ratio diagram includes various tags and a prediction ratio of that each tag is predicted to be another tag;

building a target loss function based on the plurality of sample image pairs; and

training the first image classifying model based on the target loss function to determine a target image classifying model.

In some embodiments, the program for training the image classifying model, when executed by the processor, implements the following steps:

determining a plurality of target tags corresponding to each sample image based on the first image classifying model;

determining a prediction ratio of that each tag is predicted to be another tag based on the plurality of target tags and a pre-tagged first tag of each sample image; and

generating the tag ratio diagram based on the prediction ratio.

In some embodiments, the program for training the image classifying model, when executed by the processor, implements the following steps:

determining a prediction vector of each sample image based on the first image classifying model, the prediction vector containing a plurality of tags and a probability value corresponding to each tag; and

determining tags of which the probability values rank ahead as target tags of the sample image corresponding to the prediction vector.

In some embodiments, the program for training the image classifying model, when executed by the processor, implements the following steps:

grouping the plurality of sample images according to the pre-tagged first tag, one tag corresponding to one group;

for each group, determining the number of each tag in the plurality of target tags corresponding to each sample image in the group; and

determining a quotient of the number of each tag and the number of the sample images in the group as a prediction ratio of that the tag corresponding to the group is predicted to be each tag.

In some embodiments, the program for training the image classifying model, when executed by the processor, implements the following steps:

determining a second tag with a minimal prediction ratio to and a third tag with a maximal prediction ratio to the first tag of each sample image according to the tag ratio diagram;

randomly extracting one sample image from a group corresponding to the second tag as a most difficult sample image of each sample image;

randomly extracting one sample image from a group corresponding to the third tag as a most similar sample image of each sample image; and

determining each sample image, the most similar sample image of the sample image and the most difficult sample image of the sample image as a sample image pair of each sample image.

In some embodiments, the program for training the image classifying model, when executed by the processor, implements the following steps:

building a loss function based on the plurality of sample image pairs, wherein the loss function is determined based on a first desired distance between each sample image and the most similar sample image of the corresponding sample image, a second desired distance between each sample image and the most difficult sample image of the corresponding sample image and a minimal distance between the first desired distance and the second desired distance; and

performing weighted summation on the loss function and a classification loss function to obtain a target loss function, the classification loss function indicating classification loss of the first image classifying model.

The present disclosure further provides a computer program product, including a computer program, wherein the computer program includes a program instruction and is stored on the computer-readable storage medium, and the program instruction, when being executed by a processor, implements the steps in any one of the above methods for training the image classifying model.

Other embodiments of the present disclosure will be apparent to those skilled in the art after considering this specification or practicing the disclosed disclosure herein. The application is intended to cover any variations, uses, or adaptations of the present disclosure; and these variations, uses, or adaptations follow the general principle of the present disclosure and include common general knowledges or conventional technical means undisclosed by the present disclosure in the art. The specification and the embodiments are to be considered examples only, with a true scope and spirit of the present disclosure being indicated by the following claims.

It should be understood that, the present disclosure is not limited to the precision structure described above and shown in the drawings, and various alterations and modifications can be made without departing from the scope of the present disclosure. The scope of the present disclosure is only limited by the appended claims.

To resolve a problem existing in the related art, the present disclosure provides a method and apparatus for training an image classifying model and a server.

In one aspect, a method for training an image classifying model is provided and includes: constructing a tag route diagram based on pre-tagged sample images and a pre-trained first image classification model; selecting a plurality of sample images from the pre-tagged sample images; determining, by means of the tag route diagram, a most-similar sample image and a most-difficult sample image of each sample image of the plurality of sample images, wherein each of the sample images constitutes image pairs with the corresponding most-similar sample image thereof and the corresponding most-difficult sample image thereof; constructing a target loss function according to the image pairs and training according to the target loss function to obtain a second image classification model; and performing tag identification to an image to be identified via the second image classification model.

In another aspect, an apparatus for training an image classifying model is provided and includes: a constructing module configured to construct a tag route diagram based on pre-tagged sample images and a pre-trained first image classification model; a selecting module configured to select a plurality of sample images from the pre-tagged sample images; a determining module configured to determine the most-similar sample image and the most-difficult sample image of each sample image of the plurality of sample images by means of the tag route diagram, wherein each of the sample images constitutes image pairs with the most-similar sample image thereof and the most-difficult sample image thereof; a training module configured to construct a target loss function according to the image pairs and training according to the target loss function to obtain a second image classification model; and an identification module configured to perform tag identification to an image to be identified via the second image classification model.

In another aspect, an apparatus for training an image classifying model is provided and includes: a processor; and a memory for storing a processor executable instruction; wherein the processor is configured to construct a tag route diagram based on pre-tagged sample images and a pre-trained first image classification model; selecting a plurality of sample images from the pre-tagged sample images; determining the most-similar sample image and the most-difficult sample image of each sample image of the plurality of sample images by means of the tag route diagram, wherein each of the sample images constitutes image pairs with the most-similar sample image thereof and the most-difficult sample image thereof; constructing a target loss function according to the image pairs and training according to the target loss function to obtain a second image classification model; and performing tag identification to an image to be identified via the second image classification model.

In another aspect, a server is provided and includes: a memory, a processor and a program for training an image classifying model stored on the memory and capable of running on the processor, wherein the program for training an image classifying model, when being executed by the processor, implements the steps in the method for training an image classifying model according to any one of the claims.

In another aspect, a computer readable storage medium is provided. A program for training an image classifying model being stored on the computer readable storage medium, wherein the program for training an image classifying model, when being executed by the processor, implements the steps in the method for training an image classifying model according to any one of the claims.

In another aspect, a computer program product if further provided. The computer program product includes a computer program, wherein the computer program includes a program instruction and is stored on the computer readable storage medium, the program instruction, when being executed by the processor, implementing the steps in the method for training an image classifying model according to any one of the claims.

The technical solution provided by the embodiments of the present disclosure can have the following beneficial effects.

According to the image classifying model training solution provided by the embodiments of the present disclosure, the tag route diagram is constructed based on the pre-tagged sample images and the pre-trained first image classification model; by means of the tag route diagram, the most-similar sample image and the most-difficult sample image of each of the sample images are determined to constitute image pairs; the target loss function is constructed according to the image pairs, and training is performed according to the target loss function to obtain the second image classification model; and as for the method for training a target classification model, the convergence rate of the model is high, tag classification is more refined, and the tag identification accuracy of the target classification model is high.

It should be understood that the above general description and details later merely provide examples and are explanatory without limiting the present disclosure.

What is claimed is:

1. A method for training an image classifying model, the method comprising:
selecting a plurality of sample images from a sample image set comprising pre-tagged sample images;
determining a plurality of sample image pairs according to a tag ratio diagram, wherein each sample image pair comprises one sample image, and a most similar sample image and a most difficult sample image of the sample image, wherein the tag ratio diagram is built by identifying the sample image set based on a first image classifying model, and the tag ratio diagram comprises various tags and a prediction ratio of each tag being predicted to be another tag;
building a target loss function based on the plurality of sample image pairs; and
training the first image classifying model based on the target loss function to determine a target image classifying model.

2. The method according to claim 1, further comprising:
determining a plurality of target tags corresponding to each sample image based on the first image classifying model;
determining a prediction ratio of each tag being predicted to be another tag based on the plurality of target tags and a pre-tagged first tag of each sample image; and
generating the tag ratio diagram based on the prediction ratio.

3. The method according to claim 2, wherein determining the plurality of target tags corresponding to each sample image based on the first image classifying model comprises:
determining a prediction vector of each sample image based on the first image classifying model, wherein the prediction vector comprises a plurality of tags and a probability value corresponding to each tag; and
determining tags of which the probability values rank ahead as target tags of the sample image corresponding to the prediction vector.

4. The method according to claim 2, wherein determining the prediction ratio of each tag being predicted to be another tag based on the plurality of target tags and the pre-tagged first tag of each sample image comprises:
grouping the plurality of sample images according to the pre-tagged first tag, one tag corresponding to one group;
for each group, determining the number of each tag in the plurality of target tags corresponding to each sample image in the group; and
determining a quotient of the number of each tag and the number of the sample images in the group as the prediction ratio of a tag corresponding to the group being predicted to be each tag.

5. The method according to claim 1, wherein determining the plurality of sample images comprises:
determining a second tag with a minimal prediction ratio to the first tag of each sample image and a third tag with a maximal prediction ratio to the first tag of each sample image according to the tag ratio diagram;
randomly extracting one sample image from a group corresponding to the second tag as a most difficult sample image of each sample image;
randomly extracting one sample image from a group corresponding to the third tag as a most similar sample image of each sample image; and
determining each sample image, the most similar sample image of the sample image and the most difficult sample image of the sample image as a sample image pair of the sample image.

6. The method according to claim 1, wherein building the target loss function based on the plurality of sample image pairs comprises:
building a loss function based on the plurality of sample image pairs, wherein the loss function is determined based on a first desired distance between each sample image and the most similar sample image of the sample image, a second desired distance between the sample image and the most difficult sample image of the sample image and a minimal distance between the first desired distance and the second desired distance; and
performing weighted summation on the loss function and a classification loss function to obtain a target loss function, wherein the classification loss function indicates classification loss of the first image classifying model.

7. A server, comprising a memory, a processor and a computer program which is stored on the memory and is capable of being executed on the processor, wherein the computer program, when executed by the processor, implements a method comprising:
selecting a plurality of sample images from a sample image set comprising pre-tagged sample images;
determining a plurality of sample image pairs according to a tag ratio diagram, wherein each sample image pair comprises one sample image, and a most similar sample image and a most difficult sample image of the sample image, wherein the tag ratio diagram is built by identifying the sample image set based on a first image classifying model, and the tag ratio diagram comprises various tags and a prediction ratio of each tag being predicted to be another tag;
building a target loss function based on the plurality of sample image pairs; and
training the first image classifying model based on the target loss function to determine a target image classifying model.

8. The server according to claim 7, wherein the method further comprises:
determining a plurality of target tags corresponding to each sample image according to the first image classifying model;
determining a prediction ratio of each tag being predicted to be another tag based on the plurality of target tags and a pre-tagged first tag of each sample image; and
generating the tag ratio diagram based on the prediction ratio.

9. The server according to claim 8, wherein the method further comprises:
determining a prediction vector of each sample image based on the first image classifying model, wherein the prediction vector contains a plurality of tags and a probability value corresponding to each tag; and
determining tags of which the probability values rank ahead as target tags of the sample image corresponding to the prediction vector.

10. The server according to claim 8, wherein the method further comprises:
grouping the plurality of sample images according to the pre-tagged first tag, one tag corresponding to one group;
for each group, determining the number of each tag in the plurality of target tags corresponding to each sample image in the group; and
determining a quotient of the number of each tag and the number of the sample images in the group as the prediction ratio of a tag corresponding to the group being predicted to be each tag.

11. The server according to claim 7, wherein the method further comprises:
determining a second tag with a minimal prediction ratio to and a third tag with a maximal prediction ratio to the first tag of each of the sample images according to the tag ratio diagram;
randomly extracting one sample image from a group corresponding to the second tag as a most difficult sample image of each sample image;
randomly extracting one sample image from a group corresponding to the third tag as a most similar sample image of each sample image; and
determining each sample image, the most similar sample image of the sample image and the most difficult sample image of the sample image as a sample image pair of the sample image.

12. The server according to claim 7, wherein the method further comprises:
building a loss function based on the plurality of sample image pairs, wherein the loss function is determined based on a first desired distance between each sample image and the most similar sample image of the sample image, a second desired distance between each sample image and the most difficult sample image of the sample image and a minimal distance between the first desired distance and the second desired distance; and
performing weighted summation on the loss function and a classification loss function to obtain a target loss function, wherein the classification loss function indicates classification loss of the first image classifying model.

13. A computer-readable storage medium with a computer program stored thereon, wherein the computer program, when executed by a processor, implements a method comprising:
selecting a plurality of sample images from a sample image set comprising pre-tagged sample images;
determining a plurality of sample image pairs according to a tag ratio diagram, wherein each sample image pair comprises one sample image, and a most similar sample image and a most difficult sample image of the sample image, wherein the tag ratio diagram is built by identifying the sample image set based on a first image classifying model, and the tag ratio diagram comprises various tags and a prediction ratio of each tag being predicted to be another tag;
building a target loss function based on the plurality of sample image pairs; and
training the first image classifying model based on the target loss function to determine a target image classifying model.

14. The computer-readable storage medium according to claim 13, wherein the method further comprises:
determining a plurality of target tags corresponding to each sample image based on the first image classifying model;
determining a prediction ratio of each tag being predicted to be another tag based on the plurality of target tags and a pre-tagged first tag of each sample image; and
generating the tag ratio diagram based on the prediction ratio.

15. The computer-readable storage medium according to claim 14, wherein the method further comprises:
determining a prediction vector of each sample image based on the first image classifying model, wherein the prediction vector contains a plurality of tags and a probability value corresponding to each tag; and
determining tags of which the probability values rank ahead as target tags of the sample image corresponding to the prediction vector.

16. The computer-readable storage medium according to claim 14, wherein the method further comprises:
grouping the plurality of sample images according to the pre-tagged first tag, one tag corresponding to one group;
for each group, determining the number of each tag in the plurality of target tags corresponding to each sample image in the group; and
determining a quotient of the number of each tag and the number of the sample images in the group as the prediction ratio of a tag corresponding to the group being predicted to be each tag.

17. The computer-readable storage medium according to claim 13, wherein the method further comprises:
determining a second tag with a minimal prediction ratio to and a third tag with a maximal prediction ratio to the first tag of each of the sample images according to the tag ratio diagram;
randomly extracting one sample image from a group corresponding to the second tag as a most difficult sample image of sample image;
randomly extracting one sample image from a group corresponding to the third tag as a most similar sample image of each sample image; and
determining each sample image, the most similar sample image of the sample image and the most difficult sample image of the sample image as a sample image pair of each sample image.

18. The computer-readable storage medium according to claim 13, wherein the method further comprises:
building a loss function based on the plurality of sample image pairs, wherein the loss function is determined based on a first desired distance between each sample image and the most similar sample image of the corresponding sample image, a second desired distance between each sample image and the most difficult sample image of the corresponding sample image and a minimal distance between the first desired distance and the second desired distance; and
performing weighted summation on the loss function and a classification loss function to obtain a target loss function, wherein the classification loss function indicates classification loss of the first image classifying model.
